(19) United States
(12) Patent Application Publication
(10) Pub. No.: US 2008/0252600 A1
(43) Pub. Date: Oct. 16, 2008

(54) ADAPTABLE CONTROL DEVICE

(76) Inventors: Thorsten Hagner, Ilvesheim (DE); Alain Blind, Birkenau (DE)

Correspondence Address: DEERE & COMPANY, ONE JOHN DEERE PLACE, MOLINE, IL, 61265, US

(21) Appl. No.: 12/039,814

(22) Filed: Feb. 29, 2008

(30) Foreign Application Priority Data
Apr. 11, 2007 (DE) 10 2007 017313.1

(51) Int. Cl. G06F 3/033

(52) U.S. Cl. 345/161

(57) ABSTRACT

The invention relates to a control device for controlling vehicle functional units. There is a need for a control device which can be used for controlling a variety of different functional units without there being uncertainty with respect to what function is being controlled. The control device is adapted to control a selected one of a variety of different vehicle functional units. At least one display element is associated with the control device. The display element displays an image associated with the functional unit which is being controlled by the control device.

This application claims priority to Application No.: DE 10 2007 017313.1, filed 11 Apr. 2007, which is now abandoned.

### FIELD OF THE INVENTION

The present invention relates to a control device for a vehicle.

### BACKGROUND OF THE INVENTION

Control devices of various types have long been used to activate and control vehicle functional units. Known conventional control devices include control sticks, joysticks, control levers or rotary knobs. Such a control device is normally assigned to or used to activate or control only a single vehicle functional unit. A control device is normally not assigned to multiple functional units, since there is a risk that the vehicle operator, desirous of using the control device to control a particular functional unit, may instead control a different functional unit as a result of the current operating state of the control device, resulting in incorrect operation.

Therefore, at present a separate control device or control device is provided for each group of functional units, such that an operator basically actuates the control device which always activates a particular vehicle functional unit.

### SUMMARY OF THE INVENTION

Accordingly, an object of this invention is to provide a control device can be used to control a variety of different functional units.

This and other objects are achieved by the present invention, wherein at least two different functional units may be assigned or allocated to a single control device. The control device includes display elements which display a symbol indicating the functional unit with which the control device is associated.

According to the invention, it was firstly recognized that different vehicle functional units can be controlled by one and the same control device, if display elements are provided to indicate the current vehicle functional unit to which the control device is assigned. For instance, a joystick is provided with at least one display element. This display element displays a symbol or legend which indicates to an operator that the joystick is at present controlling a particular functional unit, such as a front end loader of a tractor. If an implement such as a round baler, is coupled to the tractor, then a functional unit of the round baler could be controlled by the joystick. In this case, the display element would display a symbol or legend indicating to an operator that the joystick is at present controlling the round baler.

Therefore, with this control device, a single control device may be used to control different vehicle functional units, since different functional units may be assigned to the control device and the current function assignment may be displayed or indicated to an operator by a variable display. Incorrect operation of the control device is largely ruled out in this way. The control device may be control stick, a control lever, a joystick, a rotary knob or a multifunctional pushbutton switch.

The display element could be an illuminated symbol or an illuminated legend. In principle, a tactile symbol or tactile legend would be additionally or alternatively feasible, as used with reading equipment for the blind.

Preferrably, the display shows a symbol associated with the functional unit to which the control device is assigned. A legend may be displayed in different languages, so that the legend may be set in operator-specific manner or by the vehicle manufacturer in a country-specific language.

The display element me be an LCD (Liquid Crystal Device), a TFT (Thin film transistor) or an LED (Light Emitting Diode) element. Preferrably, the display element is an OLED (Organic Light Emitting Diode) element. Such a light source element which may be a film such as has been used in MP3 players or in mobile phones.

If the display element comprises an OLED element, the OLED element may be arranged over a large area of the surface of the control device. Comparably, such an OLED display element could cover the surface of the control device completely or virtually completely. Also, a pushbutton or switch element may be arranged on the control device, and such an element may also be covered by part of the OLED element or may include its own OLED element. Such a joystick functions not only as a control device, but also as an information display. The display element could display in black and white, greyscale and/or color. It is preferable for the display element to display in color.

Preferably, the display element is arranged directly on the control device, and on an upper portion of a joystick. For instance, four display units could be provided on the joystick to display to the operator which function will be controlled by the joystick. In the case of a rotary knob, the display elements may be arranged stationarily on an outer region of the rotary knob at different detent positions of the rotary knob. This would display to the operator which function, symbolized by the respective display element, is currently set or activated with the rotary knob.

The display element is preferably placed on or part of a pushbutton or switch element. For instance, a display element could be placed on a pushbutton switch arranged on a joystick to activate a hydraulic function of a front end loader, such as bringing the loading shovel into a predetermined transport position. If a round baler is coupled to the vehicle, the ejector mechanism for the round bales could be activated using the same pushbutton switch, in which case a corresponding symbol would be displayed on the pushbutton switch.

The vehicle function could comprise one or more functional units of the transmission management system and/or of the vehicle lighting system and/or of the engine management system.

The functional unit could be an implement which may be detachably coupled to the vehicle, such as a front end loader, a round baler, a mower, a seed drill, a sprayer, a plough, a harrow or any other agricultural implement. The functional unit could be a hydraulic, electrical and/or pneumatic. If the vehicle is a tractor, the working function could be the lifting cylinder of a three-point hitch.

Preferably, the display is changed automatically to show an appropriate symbol or legend, such as in response to an implement being coupled to a tractor, which implement is controlled via a so-called ISO Bus pursuant to ISO standard 11783). As soon as this is displayed, the implement could also be controlled directly with the control device. However, the display element could also be manually changed with a changeover element. For example, the display and the control element could be changed between control of the vehicle lighting system and of the engine management system. As soon as the changeover element is actuated, the display element could accordingly display a symbol or a legend for the respective vehicle or working function. If an automatic or manual changeover process is provided, an audible signal could be produced, to make the vehicle operator aware of the changeover and the new control device function assignment.

A control unit could be provided to activate the display element or the display elements. Likewise, the signals generated by the control device, which are generated by operator actuation, are supplied by the control unit to the respective vehicle functional unit.

According to a preferred embodiment, the display unit is assignable with symbols and characters individually and/or in operator-specific manner. Preferably, such an assignment may be stored and called up again. Operator-specific assignment of the symbols or characters shown by the display unit may assist in setting up a working environment adapted to the operator, so increasing individual productivity. A stored configuration could be called up again automatically using a user identifier, a code, or the operator's ID card.

Preferably, no further display means is provided for operation of the control device. The control device according to the invention is thus in particular not a monitor with individual operating keys or a so-called virtual terminal.

### BRIEF DESCRIPTION OF THE DRAWINGS

FIG. 1 is a schematic perspective view of an embodiment of a control device according to the invention;

FIG. 2 is a diagram of a second embodiment of a control device according to the invention;

FIG. 3a is a diagram showing symbols displayed by a display element associated with the embodiment of FIG. 1; and

FIG. 3b is a diagram showing symbols displayed by a display element associated with the embodiment of FIG. 2.

### DESCRIPTION OF THE PREFERRED EMBODIMENT

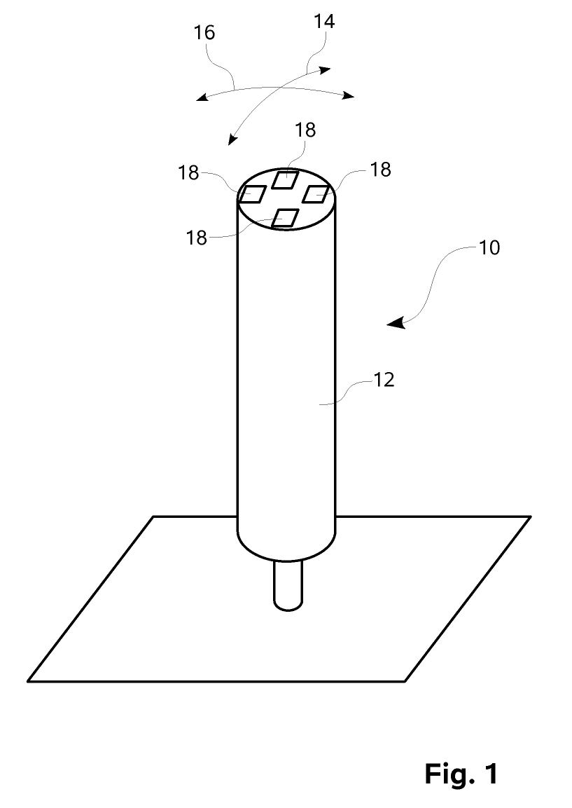

FIG. 1 shows a control device 10 for a vehicle (not shown), such as a tractor. The control device 10 comprises a joystick 12 and may be deflected in two mutually independent directions 14, 16 and combinations thereof. In direction 14 the joystick 12 may be deflected forwards or backwards. In direction 16 the joystick 12 may be deflected to the left or right. The joystick 12 may be used to control a front end loader (not shown) coupled to the tractor. If the joystick 12 is deflected forwards or backwards, the boom of the front end loader is raised or lowered, respectively. If the joystick 12 is deflected to the left or right, the loading shovel is tipped downwards or upwards. Allocated to the joystick 12 are four display elements 18, which are arranged in an upper area of the joystick 12. They serve to display the front end loader function which may be implemented with the joystick 12. Thus, corresponding images or symbols (not shown in FIG. 1) are displayed by the display elements 18. On the outer cylindrical surface of the joystick 12 there is arranged a further display element 18 which may be in the form of a pushbutton switch (not shown). This pushbutton switch may be actuated with the operator's thumb. This pushbutton switch may likewise have at least two different function assignments allocated to it depending on the situation, such that different functional units may be activated with the joystick 12 or with the pushbutton switch. Depending on the respectively allocated function of the pushbutton switch, a corresponding symbol or a corresponding legend is displayed on the display unit of the pushbutton switch, such that an operator may recognize which function he will activate with the pushbutton switch.

If an implement (not shown) is then coupled to the tractor, the implement is preferably controllable via an ISO Bus (not shown), and the joystick 12 is used to control the implement. To this end, in accordance with the invention, the joystick 12 is provided in situation-dependent manner with a different function assignment, namely controlling the implement instead of the front end loader. In this case, the display elements 18 on the joystick 12 in each case display other symbols, namely symbols which are associated with the function of the implement. The display elements 18 each comprise an OLED element and are luminescent light sources with a symbolic color display.

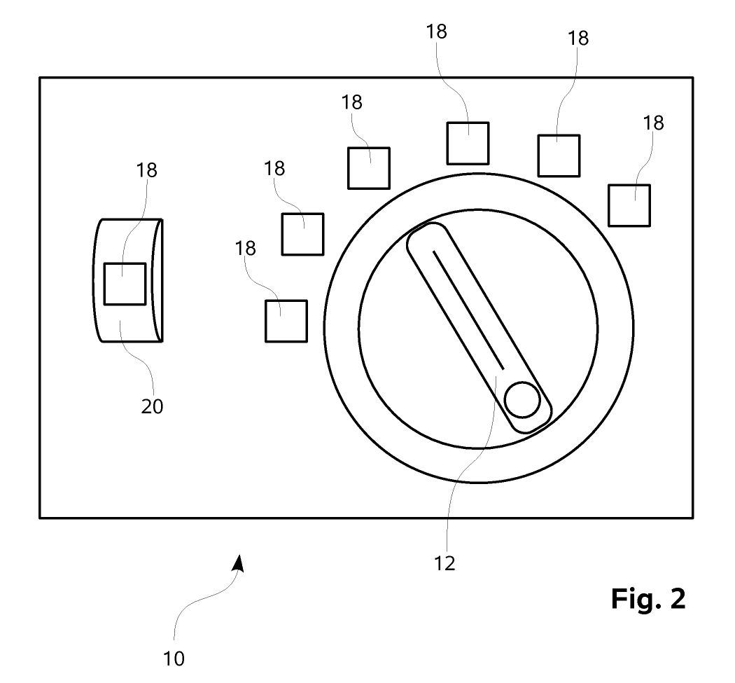

FIG. 2 shows a second exemplary embodiment of a control device 10A according to the invention wherein the control device 10A comprises a rotary knob 12A. The rotary knob 12A has four different rotary positions. Each rotary position is associated with a display element 18A arranged on a housing 19 on which the knob 12A is mounted. The display elements 18 in FIGS. 1 and 2 are indicated schematically, without showing symbols or legends. The control device 10A includes a changeover element 20, which is a rocker switch or toggle switch. The rocker switch has a neutral operating state. By pressing the left-hand pushbutton switch face, a first changeover signal is generated and supplied to a control unit (not shown). By pressing the right-hand pushbutton switch face, a second changeover signal is generated, which is supplied to the control unit. The changeover element 20 also includes a display unit 18, which displays the respectively set state of the changeover element 20. This display unit 18 could also be arranged below or near the changeover element 20. Depending on the respectively set state of the changeover element 20, the knob 12A is assigned a corresponding function assignment. Accordingly, the four display units 18 near the rotary knob 12A each display different symbols. The symbols displayed correspond to the respective function assignment of the rotary position of the knob 12A.

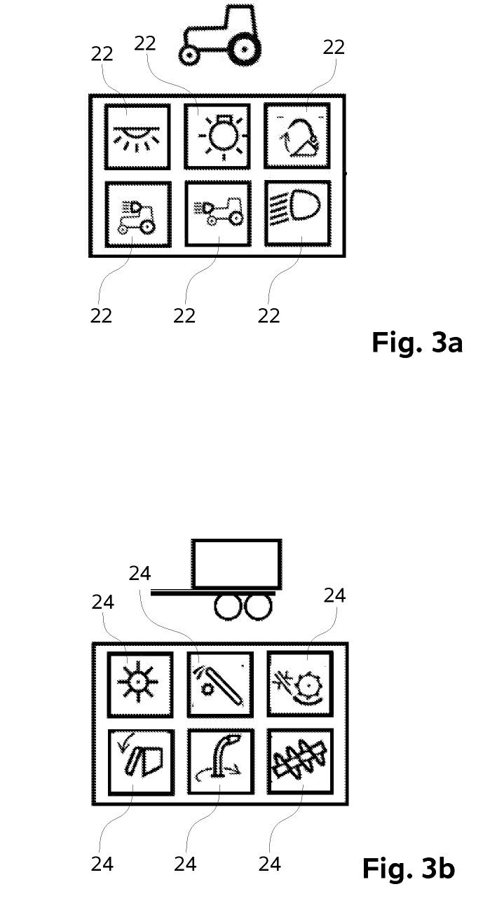

FIG. 3a is a schematic representation of six different symbols 22 which could be displayed on a display element 18 if the corresponding control device 10 has a first function assignment relating to the vehicle or tractor. FIG. 3b is a schematic representation of six different symbols 24 which could be displayed on a display element 18 if the corresponding control device 10 has a second function assignment relating to an implement which may be coupled to the vehicle or tractor.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A vehicle control device for controlling a vehicle functional unit, the control device having a display element associated therewith, the display element displaying an image associated with the vehicle functional unit which may be controlled by the control device, characterized in that:
the control device may be used to control at least two different functional units, and in that the display element changes to indicate which of the functional units is being controlled by the control device.

2. The control device of claim 1, wherein:
the control device comprises a control lever, a joystick, a rotary knob or a multifunctional pushbutton switch.

3. The control device of claim 1, wherein:
the display element displays an illuminated symbol or an illuminated legend.

4. The control device of claim 3, wherein:
the display device displays different symbols, the displayed symbol depending upon which of the functional units the control device is controlling.

5. The control device of claim 3, wherein:
the display element comprises an LCD, a TFT, an LED or an OLED element.

6. The control device of claim 1, wherein:
the display element displays in black and white, greyscale and/or colour.

7. The control device of claims 1, wherein:
the display element is arranged directly on the control device.

8. The control device of claims 1, wherein:
the display element is associated indirectly with the control device.

9. The control device of claim 1, wherein:
the display element comprises a pushbutton or switch element.

10. The control device of claim 1, wherein:
images displayed by the display element are changed in response to manual operation of a changeover element.

11. The control device of claim 1, wherein:
images displayed by the display element are changed automatically.

12. The control device of claim 1, wherein:
the display unit is assignable with operator-selectable symbols or characters.

13. The control device of claim 1, wherein:
the display element is the only display means provided for operation of the control device.
